(19) United States
(12) Patent Application Publication
(10) Pub. No.: US 2016/0267520 A1
(43) Pub. Date: Sep. 15, 2016

(54) METHOD AND SYSTEM FOR ONLINE USER ENGAGEMENT MEASUREMENT

(71) Applicant: Bidtellect, Inc., Delray Beach, FL (US)

(72) Inventors: Kristopher Kalish, Delray Beach, FL (US); Jeremy Kayne, Boca Raton, FL (US); Michael Weaver, Parkland, FL (US); John Ferber, Delray Beach, FL (US); Lon Otremba, Boynton Beach, FL (US)

(21) Appl. No.: 14/643,491

(22) Filed: Mar. 10, 2015

(51) Int. Cl. G06Q 30/02

(52) U.S. Cl. CPC G06Q 30/0242; G06Q 30/0272

(57) ABSTRACT

The present teaching relates to online user engagement measurement. In one example, user activities with respect to a piece of content are detected. The user activities include visiting a web site in association with the piece of content. A plurality of variables are determined based on the detected user activities. The plurality of variables include a number of web pages loaded in the web site. An engagement scoring model is obtained. An engagement score of the piece of content is estimated based on the plurality of variables and the engagement scoring model.

### BACKGROUND

1. Technical Field

The present teaching relates to methods, systems, and programming for Internet service. More specifically, the present teaching is directed to methods, systems, and programming for online user engagement measurement.

2. Discussion of Technical Background

In the world of marketing, marketers traditionally use conversion rates, such as click-through-rates (CTR), to measure the performance of their campaigns. In some scenarios, it makes sense to define a conversion goal and measure the conversion rate. However, this is not possible in all scenarios, for example, in content marketing.

Content marketing is a form of marketing involving the generation and sharing of valuable content and media to acquire customers. If an advertiser is trying to drive traffic to their content marketing efforts, there is no clear conversion goal. Conversion goals are fundamentally tied to discrete events, that is to say the event either occurs or does not. However, with content marketing, progress is more continually measurable. For instance, if an advertiser drives traffic to their web site and a user spends one minute on the web site, that is great; but if a user spends two minutes on the web site, that is even better. This phenomenon makes it difficult to use a particular time-on-site as a conversion goal because for any target time-on-site there is always another goal time that is better.

Therefore, there is a need to provide an improved solution for online user engagement measurement to solve the above-mentioned problems.

### SUMMARY

The present teaching relates to methods, systems, and programming for Internet service. More specifically, the present teaching is directed to methods, systems, and programming for online user engagement measurement.

In one example, a method, implemented on a computing device having at least one processor, storage, and a communication platform capable of connecting to a network for user engagement measurement is disclosed. User activities with respect to a piece of content are detected. The user activities include visiting a web site in association with the piece of content. A plurality of variables are determined based on the detected user activities. The plurality of variables include a number of web pages loaded in the web site. An engagement scoring model is obtained. An engagement score of the piece of content is estimated based on the plurality of variables and the engagement scoring model.

In another example, a method, implemented on a computing device having at least one processor, storage, and a communication platform capable of connecting to a network for providing content is disclosed. User activities with respect to each of a plurality pieces of content are detected. The user activities include visiting a web site in association with the respective piece of content. A plurality of variables for each of the plurality pieces of content are determined based on the detected user activities. The plurality of variables include at least a number of web pages loaded in the web site and a number of visits to the web site that last less than a threshold. An engagement scoring model is obtained. An engagement score of each of the plurality pieces of content is estimated based on the corresponding plurality of variables and the engagement scoring model. A request for providing content to a user is received. At least one of the plurality pieces of content is selected based on the estimated engagement scores of the plurality pieces of content. The at least one of the plurality pieces of content is provided to the user.

In a different example, a system for user engagement measurement is disclosed. The system includes user activity monitor and a user engagement score estimator. The user activity monitor is configured to detect user activities with respect to a piece of content. The user activities include visiting a web site in association with the piece of content. The user activity monitor is further configured to determine a plurality of variables based on the detected user activities. The plurality of variables include a number of web pages loaded in the web site. The user engagement score estimator is configured to obtain an engagement scoring model and estimate an engagement score of the piece of content based on the plurality of variables and the engagement scoring model.

Other concepts relate to software for implementing the present teaching on user engagement measurement. A software product, in accord with this concept, includes at least one non-transitory machine-readable medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for user engagement measurement is disclosed. The recorded information, when read by the machine, causes the machine to perform a series of processes. User activities with respect to a piece of content are detected. The user activities include visiting a web site in association with the piece of content. A plurality of variables are determined based on the detected user activities. The plurality of variables include a number of web pages loaded in the web site. An engagement scoring model is obtained. An engagement score of the piece of content is estimated based on the plurality of variables and the engagement scoring model.

Additional features will be set forth in part in the description which follows, and in part will become apparent to those skilled in the art upon examination of the following and the accompanying drawings or may be learned by production or operation of the examples. The features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1-3 illustrate exemplary system configurations in which a user engagement measurement engine can be deployed, according to various embodiments of the present teaching;

FIG. 4 depicts providing engagement scores for each content item, according to an embodiment of the present teaching;

FIG. 5 is an exemplary system diagram of a user engagement measurement engine and a content serving engine, according to an embodiment of the present teaching;

FIG. 6 is a flowchart of an exemplary process for a user engagement measurement engine and a content serving engine, according to an embodiment of the present teaching;

FIG. 7 is a detailed exemplary system diagram of a user engagement measurement engine, according to an embodiment of the present teaching;

FIG. 8 is a flowchart of an exemplary process for a user engagement measurement engine, according to an embodiment of the present teaching;

FIG. 9 is a flowchart of an exemplary process for a user activity monitor, according to an embodiment of the present teaching;

FIG. 10 is a flowchart of an exemplary process for a content serving engine, according to an embodiment of the present teaching;

FIG. 11 illustrates an exemplary experiment result of contribution of bounce rate to engagement score as a function of bounce rate, according to an embodiment of the present teaching;

FIG. 12 illustrates an exemplary experiment result of contribution of page views per visit to engagement score, according to an embodiment of the present teaching;

FIG. 13 illustrates an exemplary experiment result of probability density function (PDF) for a Weibull distribution for certain web sites as function of time spent to the web sites, according to an embodiment of the present teaching;

FIG. 14 illustrates an exemplary experiment result of average time-on-site's contribution to engagement score, according to an embodiment of the present teaching;

FIG. 15 depicts the architecture of a mobile device which can be used to implement a specialized system incorporating the present teaching; and

FIG. 16 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present teaching describes method, system, and programming aspects of online user engagement measurement based on a novel engagement scoring model that integrates multiple types of user activity variables. The various types of variables integrated in the model can capture the continual progress of user events in content marketing, thereby more precisely and comprehensively reflecting the user engagement to the content provided, e.g., advertisements. For example, such variables include time spent on visiting a web site (time-on-site), the number of web site visits (browsing sessions), the number of web pages loaded (page views), the number of web site visits lasting less than a threshold (bounce), etc. Those variables can be used in multiple functions in a novel way so that different facets related to engagement are considered in an integral manner.

In some embodiments of the present teaching, the system and method disclosed herein can adaptively provide content (e.g., advertisements) in the context of a publisher's web page based on the engagement level between content and viewers reflected by the engagement scores. An engagement score, which signifies the level of engagement between a viewer and a content item or a specific rendering of the content items, is used in selecting the optimal content item or rendering thereof. For example, this can influent and promote optimal advertisement selection and delivery. By optimizing for engagement scores, publishers, advertisers, and end users are satisfied simultaneously: the advertisers make effective use of their budget; the advertisements are relevant to the publisher's assets; and the end users are shown content they react to.

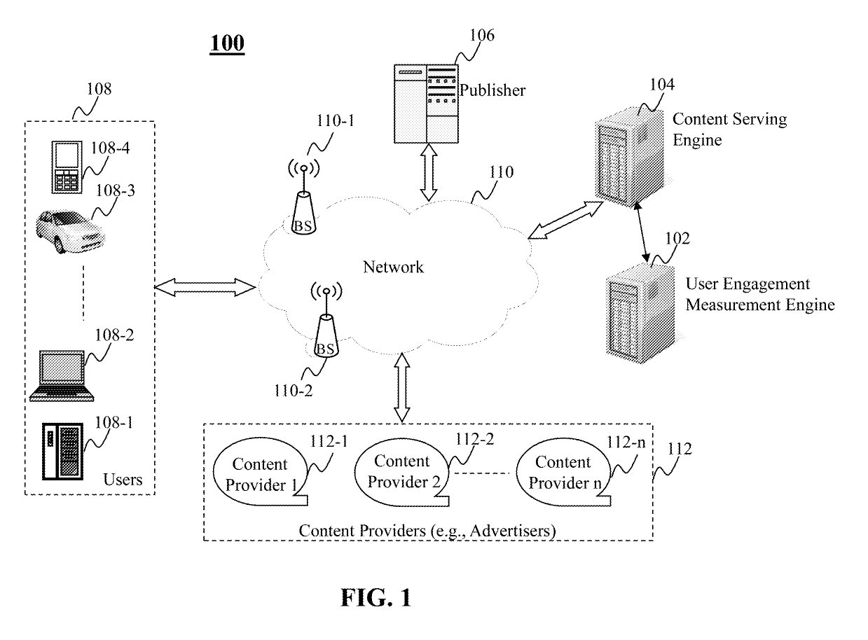

FIGS. 1-3 illustrate exemplary system configurations in which a user engagement measurement engine can be deployed, according to various embodiments of the present teaching. In FIGS. 1-3, the exemplary systems include a user engagement measurement engine 102, a content serving engine 104, a publisher 106, users 108, a network 110, and content providers 112 including a content provider 1 112-1, a content provider 2 112-2, . . . , a content provider n 112-n.

The network 110 may be a single network or a combination of different networks. For example, a network may be a local area network (LAN), a wide area network (WAN), a public network, a private network, a proprietary network, a Public Switched Telephone Network (PSTN), the Internet, a wireless network, a cellular network, a virtual network, or any combination thereof. A network may also include various network access points, e.g., wired or wireless access points such as base stations or Internet exchange points 110-1, . . . , 110-2, through which a data source may connect to the network 110 in order to transmit information via the network 110, and a network node may connect to the network 110 in order to receive information.

The users 108 may be of different types such as end users connected to the network 110 via desktop connections (108-1), users connecting to the network 110 via wireless connections such as through a laptop (108-2), a handheld device (108-4), or a built-in device in a mobile vehicle such as a motor vehicle (108-3). The users 108 may be connected to the network 110 and able to communicate with the user engagement measurement engine 102, content serving engine 104, publisher 106, and/or content providers 112.

In this embodiment, the publisher 106 may be any entity that hosts one or more spaces in its assets (e.g., web sites, applications, etc.) for presenting content items, e.g., advertisements, to the users 108. For example, advertisement spaces on the publisher 106's web site may be purchased, via advertisement placements, by advertisers to place their advertisements. The content items may be presented to the users 108 when the users 108 get access to the publisher 106's assets. The publisher 106 may also be a search engine, a blogger, a television station, a newspaper issuer, a web page host, a content portal, an online service provider, or a game server.

In this embodiment, as will be described in further detail below, the user engagement measurement engine 102 may analyze user activities (user behaviors) with respect to content presented in the publisher's 106 assets and estimate engagement scores for each content item based on the detected user activities in accordance with a novel engagement scoring model. For example, the content item may be an advertisement, and the user activities may include visiting a web site pointed to by the advertisement. Various continuous variables may be obtained from the user activities for estimating engagement scores, including but not limited to, the number of web pages loaded (page views) in the web site, the number of visits to the web site that last less than a threshold (bounce), the time spent on visiting the web site (time-on-site), and the total number of visits. The user engagement measurement engine 102 may incorporate one or more variables mentioned above into the engagement scoring model with corresponding parameters and obtain the estimated engagement scores accordingly.

In this embodiment, as will be described in further detail below, the content serving engine 104 may select content item(s) to be provided to the users 108 based on the engagement scores of candidate content items estimated by the user engagement measurement engine 102. In some embodiments, each content item may have different renderings, e.g., an advertisement may be rendered in different manners to be contextually adaptive to the web page of the publisher 106 where the advertisement is to be displayed. In this situation, each rendering of the same content item may have its own engagement score estimated by the user engagement measurement engine 102, and the content serving engine 104, in addition to select an appropriate content item, may further select a particular rendering of the content item with the highest engagement score. In some embodiments, other factors may be taken into consideration by the content serving engine 104 in selecting the optimal content item and/or rendering thereof. In one example, the content serving engine 104 may consider the context of the content item where it is to be served, such as the topic of the web page or the other content items in the publisher 106's assets. The context of the content item is not limited to content topic, but also includes stylistic features, i.e., look-and-feel, of the web page where the content item is to be displayed. In another example, information related to the users 108 to which the content item is provided may be considered by the content serving engine 104 as well, such as the geo-location and demographic information of the users 108.

The content providers 112 include multiple content providers 112-1, 112-2, . . . , 112-n, such as different advertisers or business entities whose advertisements are presented in the publisher 106's assets. A content provider 112 may correspond to a content source, including any web site hosted by an entity, whether an individual, a business, or an organization such as USPTO.gov, cnn.com and Yahoo.com, or a content feed source. In some embodiments, the content items are provided by the content providers 112 to be presented in the publisher 106's assets, and each content item is associated with the content provider 112 from which it is provided. For example, an advertisement presented on the publisher 106's web site points to another web site hosted by an advertiser. Certain user interactions with the advertisement on the publisher 106's web site, e.g., clicking, may cause the user 108 to visit the web site pointed to by the advertisement and hosted by the advertiser. Any further user activities related to the subsequent visits to the web site or any other assets (e.g., applications) of a content provider 112 are considered as being “related to” or “with respect to” the content item in the publisher 106's assets that triggers the subsequent visits. It is understood that the “triggering” events are not limited to direct user actions, such as clicking on an advertisement and being redirected to the linked web site, but also include indirect user actions. For example, after watching an online advertisement video of a product, a user 108 may not click any link on the advertisement, but instead, searches the product information via a search engine and eventually visits the product's web site. This would be considered as an indirect user action, which the advertisement video still triggers the user's visit to the product's web site, and thus has the same effect as direct user actions.

FIG. 1 shows a system configuration 100 in which the user engagement measurement engine 102 serves as a backend sub-system of the content serving engine 104, while the content serving engine 104 itself is an independent service provider in relation to the publisher 106 and the content providers 112. That is, in this system configuration 100, both the user engagement measurement engine 102 and the content serving engine 104 may be owned by the same entity, which provides independent service of selecting suitable content items from content providers 112 to be presented in the publisher 106's assets based on estimated engagement scores of each candidate content item.

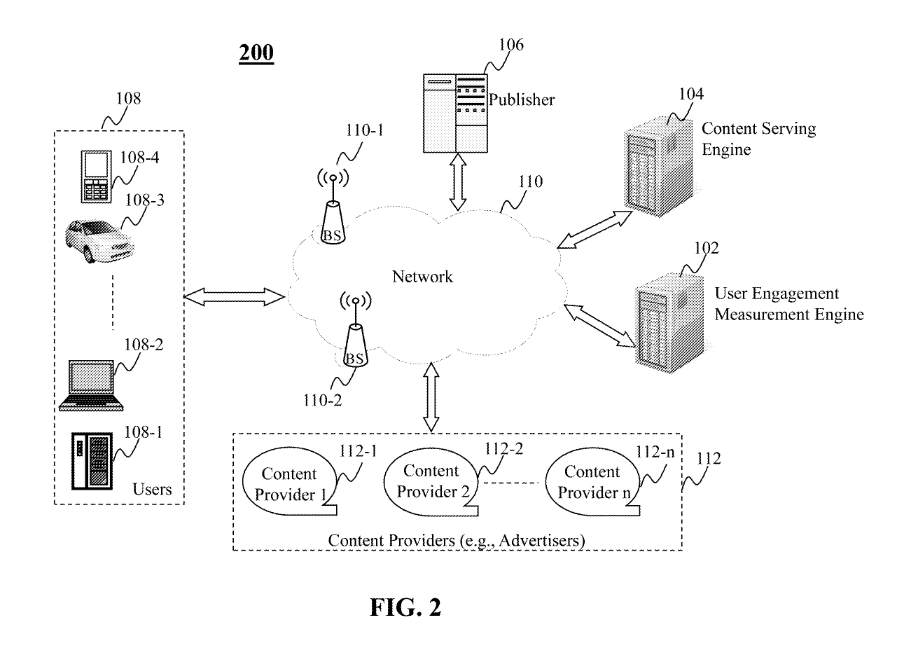

FIG. 2 presents a slightly different system configuration 200 in which the user engagement measurement engine 102 serves as an independent service provider as well. In this configuration, the user engagement measurement engine 102 and the content serving engine 104 may belong to different entities, and the user engagement measurement engine 102 may independently provide service of estimating engagement scores of any content item or rendering thereof to the content serving engine 104, or to the publisher 106 or any one of the content providers 112 directly.

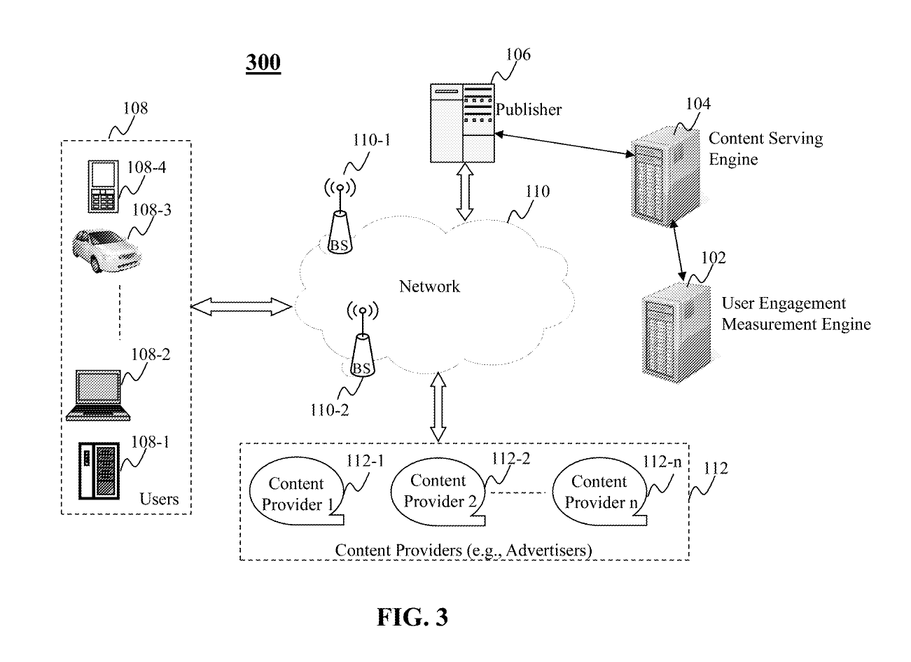

FIG. 3 presents a system configuration 300 slightly different from the system configuring 100 in FIG. 1. In this configuration, the content serving engine 104 serves as a backend sub-system of the publisher 106 for dedicatedly providing content serving service (and user engagement measurement service via the user engagement measurement engine 102) to the particular publisher 106. In other words, the publisher 106 deploys a dedicated backend sub-system including the content serving engine 104 and user engagement measurement engine 102 for improving its content serving quality, thereby attracting more traffic to its web site. Although not know in figures, one or more content providers 112 may also deploy a dedicated backend sub-system including the content serving engine 104 and user engagement measurement engine 102 or subscribe the services provided by the content serving engine 104 and user engagement measurement engine 102 in order to improve the effectiveness of its marketing campaigns.

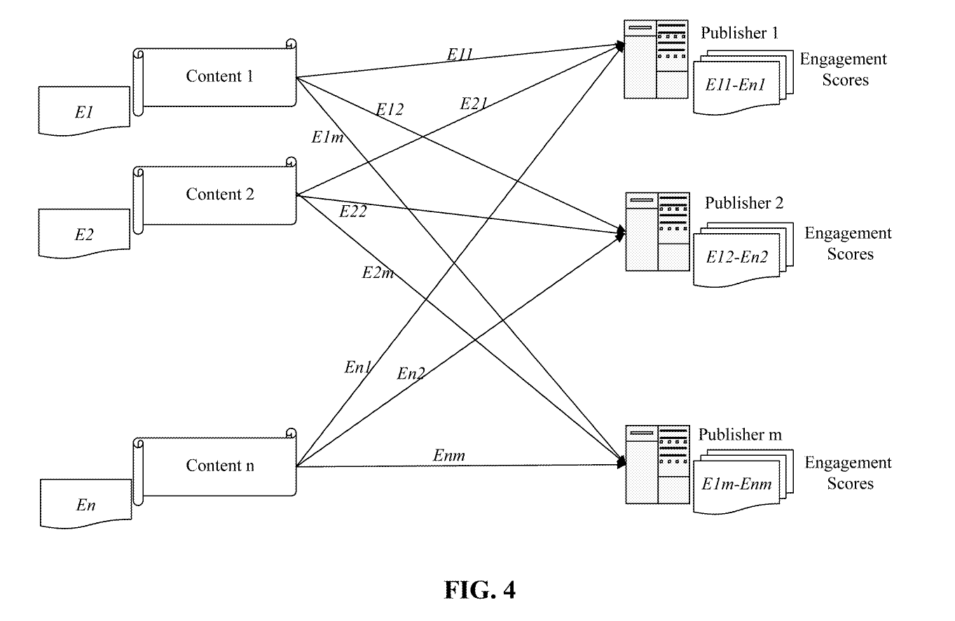

FIG. 4 depicts providing engagement scores for each content item, according to an embodiment of the present teaching. Content items 1, 2, . . . , n may be any types of content that can be presented on any one of the publishers 1, 2, . . . m. The content includes advertisements, news articles, video clips, images, etc. The same content item may be presented at different publishers. In this embodiment, the engagement scores may be estimated for each content item-publisher pair, which indicates the level of user engagement to the content item presented at the particular publisher. For example, E11 is the engagement score of content 1 presented at publisher 1, while E12 is the engagement score for the same content 1 presented at publisher 2. As shown in FIG. 4, from publishers' perspective, an array of engagement scores may be provided for all content items presented in its assets, e.g., E11-En1 for publisher 1. In this embodiment, the engagement scores may be provided for each content item, regardless of where the content item is presented. The engagement score for a content item may be the average value of all engagement scores of the content item with respect to different publishers. For example, the engagement score E1 for content 1 may be calculated as (aE11+bE12+ . . . +zE1m)/m. a, b, . . . z are weight factors for each engagement score. For example, the weight factors may be determined by the significance of the respective publisher (e.g., determined by their traffics, reputations, relationships with advertisers, etc.). It is understood that in some embodiments, no weight factors are applied (i.e., all weight factors are equal to 1).

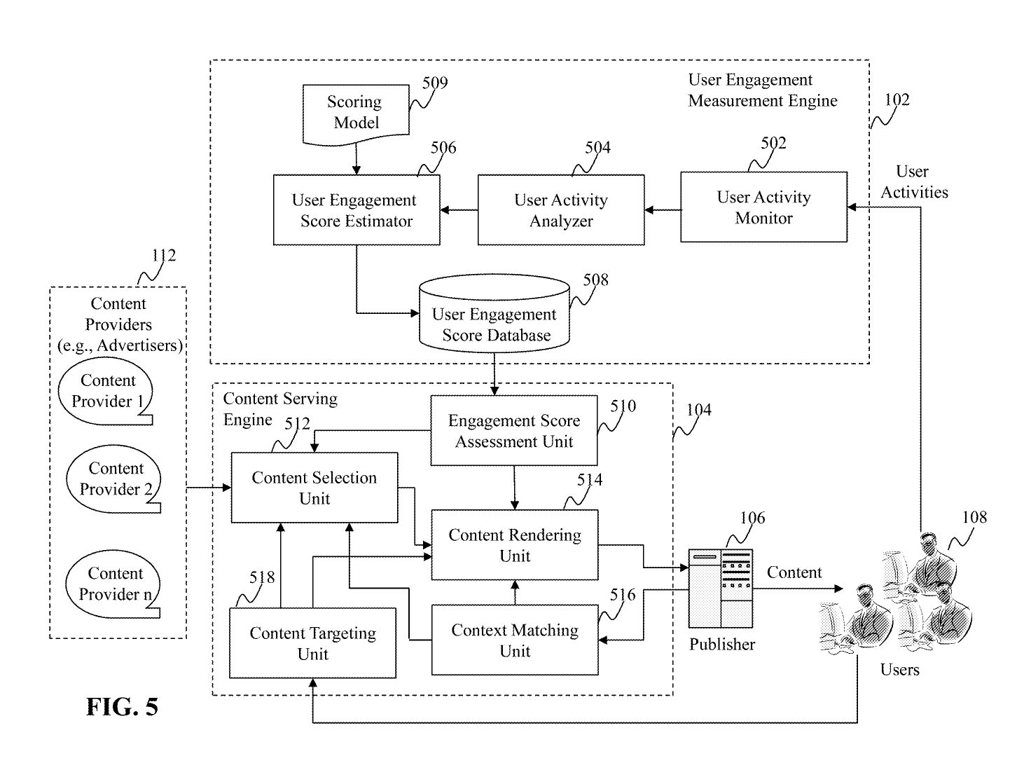

FIG. 5 is an exemplary system diagram of a user engagement measurement engine and a content serving engine, according to an embodiment of the present teaching. In this embodiment, the user engagement measurement engine 102 includes a user activity monitor 502, a user activity analyzer 504, a user engagement score estimator 506, and a user engagement score database 508. In operation, the user activity monitor 502 detects interactions of users 108 with content presented at one or more publishers 106 and monitors subsequent user activities triggered by the user interaction with the content. As mentioned above, user interactions that can trigger subsequent user activities include both direct and indirect user actions. For direct user actions, they are not limited to clicking the content item and may include other user actions, such as hovering over the content item, voice command, or finger gestures. If any user action with respect to a content item triggers the user's subsequent visiting of a web site associated with the content item, then the user activity monitor 502 may continue to monitor user activities related to visiting the web site.

The user activity monitor 502 may embed client-side applications, e.g., JavaScript, in the HTML file or applications running on the users' 108 devices, and monitor the user activities in conjunction with a tracking server. It is understood that the detection and monitoring of user activities may be implemented by any other known approaches as well, such as analyzing browser cookies. As will be described below in detail, various types of user activity variables may be monitored by the user activity monitor 502, including the number of web pages loaded (page views), the number of visits (sessions), the time spent on visiting the web site (time-on-site), and the number of visits that last less than a threshold (bounce).

In one example, the user activity monitor 502 monitors user activities with respect to an advertisement presented on a publisher's web site. Each time a user visits the publisher's web site, a JavaScript may be automatically downloaded to the user's client device as part of the HTML file of the web page where the advertisement is presented. The JavaScript in conjunction with a tracking server (as part of the user activity monitor 502) then continuously or periodically detects if the user clicks the advertisement, which will redirect the user to another web site. If the user is redirected to the other web site, the user activity variables of interest are monitored by the user activity monitor 502.

The user activity analyzer 504 in this embodiment is configured to analyze various engagement score components based on the user activity variables monitored by the user activity monitor 502. Each engagement score component may be analyzed based on one or more of the user activity variables. As will be described below in detail, the engagement score components include, for example, bounce rate, page views per visit, and time-on-site per visit (average time-on-site). The user activity analyzer 504 may set the time period of performing the analysis, e.g., one week, one month, or one year. The user activity analyzer 504 may also specify that the analysis is performed with respect to a particular user cohort (user group) or even a particular user. For example, an advertiser or a publisher may be interested in estimating an engagement score of a local restaurant advertisement from only the local customers. In this example, the analysis of engagement score components may be limited to only users who can be identified as local customers (e.g., by their geo-location information from GPS data, zip code, etc.). In another example, the user engagement score may be personalized to each specific user by limiting the analysis to only that user's online behaviors. It is understood that without specifying the user or user cohort of interest, the user activity analyzer 504 may perform the analysis with respect to general user population, e.g., all the users who have interacted with the content item of interest during the analyzing period.

In this embodiment, the user engagement score estimator 506 obtains an engagement scoring model 509 and estimates an engagement score for each content item of interest based on the user activity variables with respect to the respective content item (e.g., based on the engagement score components) and the scoring model 509. As mentioned above with respect to FIG. 4, the engagement score may be estimated for each content item-publisher pair since the same content item may have different engagement scores when it is presented on different publishers' web sites. If needed, an engagement score for a content item may be obtained by averaging all engagement scores of the same content item presented on different publishers' web sites. As will be described below in detail, the scoring model 509 may include information of how various engagement score components are combined in estimating the engagement score and the parameters associated with each engagement score component.

The estimated engagement scores are then stored in the user engagement score database 508 for different content items at the content item-publisher pair level and/or at the content item level. In addition to information of the content item and/or the publisher, each engagement score may be associated with information of its analyzing period (e.g., the year of 2014) and user cohorts (e.g., users from Florida) as well. Any suitable data structure may be used for storing and indexing the estimated engagement scores for future retrieval. For example, the engagement scores may be indexed by the content item, the publisher, the content item-publisher pair, the analyzing period, and/or the user cohort.

In this embodiment, the content serving engine 104 includes an engagement score assessment unit 510, a content selection unit 512, a content rendering unit 514, a context matching unit 516, and a content targeting unit 518. The content serving engine 104, in conjunction with the user engagement measurement engine 102, the content providers 112, and the publisher 106, may select and delivery optimal content to the users 108 by leveraging the novel approach of estimating user engagement scores for content item candidates. The engagement score assessment unit 510 accesses the user engagement score database 508 to retrieve estimated engagement scores for any content item of interest. It is understood that the same content item may be rendered differently in different styles. For example, an advertisement of a local restaurant may include the name, address, and phone number of the restaurant and a coupon. The same information, however, may be organized in different layouts, with different color themes, text fonts, etc. The different renderings of the same content item may have different levels of influence to the users and thus, may be associated with different user engagement scores. In this embodiment, even for the same content item, each of the its renderings has its own engagement score stored in the user engagement score database 508, and the engagement score assessment unit 510 can retrieve user engagement scores at the content item rendering level as well.

Both the content selection unit 512 and the content rendering unit 514 in this embodiment may obtain estimated engagement scores of candidates via the engagement score assessment unit 510. The content selection unit 512 may select one or more content items with the highest engagement scores from all candidate content items provided by the content providers 112. For example, for maximizing the return of an advertisement space on a publisher's web site, the content selection unit 512 may compare different content items (e.g., from different advertisers) when they are presented on the same publisher's web site and select the content item with the highest engagement score with respect to the particular publisher. If the selected content item has different renderings available, then the content rendering unit 514 is responsible for selecting an optimal rendering of the selected content item from all available renderings based on the estimated engagement scores thereof.

In this embodiment, the context matching unit 516 may further assist the content selection unit 512 to select content items and/or the content rendering unit 514 to determine the renderings of the selected content items. That is, the selection of content item (and rendering if needed) may not only depend on the estimated level of user engagement with respect to a candidate content item, but can also consider the degree of matching between each candidate content item or rendering thereof and its context. The context matching unit 516 may analyze the context in which the content item is to be presented. The context, as mentioned above, may include both the topic of the web page where the content item is to be presented and the style of the web page. For example, the topic may be used by the content selection unit 512 to select content items with the same or similar topic of other content items presented on the same web page. The style (look-and-feel) may be used by the content rendering unit 514 to find the rendering with the same or similar style to achieve a harmonic feeling or to select the rendering with a completely different style to make the particular content item outstanding from the surroundings.

In this embodiment, the content targeting unit 518 may further provide another facet of content and content rendering optimization. That is, the content and content rendering selection may be targeted at a specific user or user cohort of interest. If the content item is targeted for a particular user or user cohort, then the information associated with the user or user cohort may be utilized by the content targeting unit 518 for assisting the content selection unit 512 and/or content rendering unit 514. The information includes, for example, user geo-location information, user demographic information, user device information, etc.

Nevertheless, the selected content item (and the selected rendering of the content item if needed) is presented in the publisher's 106 assets for the users 108. The user interaction with such content item and the subsequent user activities can be tracked and recorded by the user engagement measurement engine 102. A continuous loop, including estimating user engagement scores for content items based on user activities and providing optimal content items to users, is thus formed by the user engagement measurement engine 102, the content serving engine 104, and the users 108. The continuous loop causes the continuous update of user engagement scores in the user engagement score database 508 based on the ever-changing user behaviors.

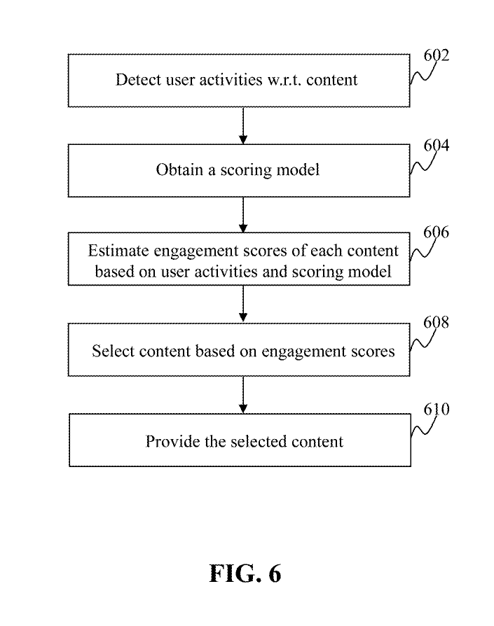

FIG. 6 is a flowchart of an exemplary process for a user engagement measurement engine and a content serving engine, according to an embodiment of the present teaching. Starting at 602, user activities with respect to a piece of content are detected. The user activities include visiting a web site in association with the piece of content. For example, the piece of content may be an advertisement presented in a publisher's assets, and the advertisement is linked to the web site. Certain user actions with respect to the advertisement, e.g., clicking on it, may cause the user to visit another web site pointed to by the advertisement. User activities related to the visit of the linked web site may be tracked and recorded. At 604, a scoring model is obtained. The scoring model may include a combination of a plurality of engagement score components, each of which is associated with one or more parameters. Each of the engagement score components may be calculated based on one or more variables of the user activities. For example, the engagement score components include bounce rate, page views per visit, and time-on-site per visit (average time-on-site). The parameters may be determined based on information of past user activities, e.g., historical user data. In one example, each engagement score component is a logistic function in the form of:

$$f ( x ) = \frac{1}{1 + {e}^{- \frac{ϰ - β}{α}}} , \qquad ( 1 )$$

where α is a parameter of the steepness of the logistic function, and β is a parameter of the center of the logistic function. At 606, engagement scores are estimated for each piece of content based on user activities with respect to the respective piece of content and the scoring model. At 608, an optimal content item is selected from candidate content items based, at least in part, on their engagement scores. Other factors, such as context of the content item and targeted users, may be taken into consideration as well. At 610, the selected content item is provided. If more than one rendering of the content item is available, an optimal rendering may be selected as well from the available renderings based on their estimated engagement scores.

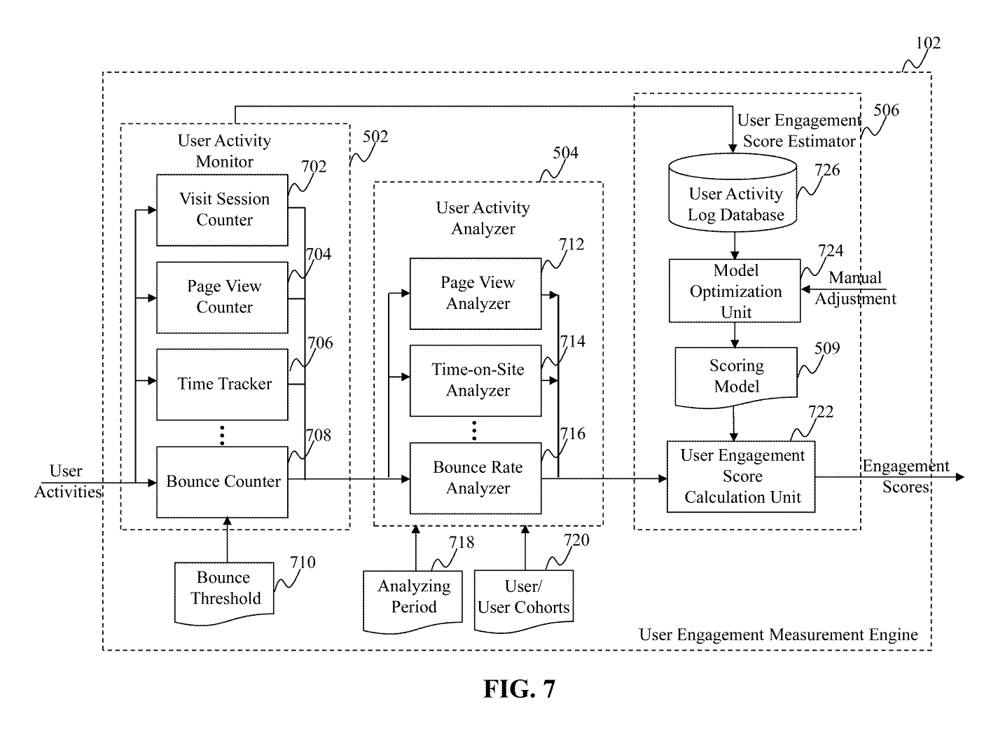

FIG. 7 is a detailed exemplary system diagram of a user engagement measurement engine, according to an embodiment of the present teaching. In this embodiment, the user activity monitor 502 includes multiple units, each of which is configured to track and record one type of user activity variables. The user activity monitor 502 may include a visit session counter 702, a page view counter 704, a time tracker 706, and a bounce counter 708. It is understood that any other user activity variable may be monitored by the user activity monitor 502 as well. As mentioned above, a JavaScript snippet may be placed on a publisher's web site or a content provider's landing page or any other web pages on which user behaviors are to be monitored.

The visit session counter 702 in this embodiment determiners the total number of visits to a web site triggered by user interaction with a content item, e.g., an advertisement. The page view counter 704 in this embodiment determines the number of web pages loaded in the web site (page views). For example, when a user clicks an advertisement and lands on the advertiser's web site, this may be considered a visit and a page view. If the user clicks a second web page of the web site, it then contributes two page views and one visit. If the user closes the browser and revisits the web site, then that is considered another visit.

The time tracker 705 in this embodiment tracks and records the time a user spent on the web site (time-on-site). The bounce counter 708 in this embodiment monitors a specific type of user behavior referred as “bounce”: visiting a web site in a time period less than a threshold 710. The threshold 710 may be, for example, 5 seconds. For example, if a user visits a web page and leaves within 5 seconds, that may considered one visit, one page view, and one bounce. The time-on-site may be measured as the time difference between the first event and last event in a visit session. For example, if a user clicks an advertisement, lands on the advertiser's landing page, reads it for one minute, then clicks a link to another article and reads that for 30 seconds before leaving (here “leaving the web site” is the last event), then the time-on-site for that visit is 1.5 minutes.

The user activity analyzer 504 in this embodiment includes a page view analyzer 712, a time-on-site analyzer 714, and a bounce rate analyzer 716, each of which is configured to analyze one engagement score component based on one or more user activity variables from the user activity monitor 502. It is understood that additional analyzers for analyzing different engagement score components may be included in the user activity analyzer 504 in some embodiments. In one example, each engagement score component may be a logistic function in the form of Equation (1) as mentioned above. β controls the center of the logistic function, which is where the function reaches the value 0.5. For example, setting β=1.0 makes Equation (1) reach a value of 0.5 when x=1.0. The second parameter α controls the steepness of the function, which is how quickly the function transitions from values of zero to one. Larger values of a make the logistic function behave more linearly near the center, while smaller values make the logistic function behave more like a step function.

The page view analyzer 712 in this embodiment is configured to calculate the component of “page views per visit”: a page loaded rate based on the number of web pages loaded in the web site and the total number of visits. In other words, the page view analyzer 712 takes the inputs from both the visit session counter 702 and the page view counter 704 to derive the “page views per visit.” The time-on-site analyzer 714 in this embodiment is responsible for calculating the component of “time-on-site per visit”: an average time-on-site based on the time spent on visiting the web site and the total number of visits. That is, the time-on-site analyzer 714 uses the inputs from both the visit session counter 702 and the time tracker 706 to derive the “time-on-site per visit.” The bounce rate analyzer 716 in this embodiment calculates the component of “bounce rate” based on the number of visits to the web site that last less than a threshold and the total number of visits. That is, the bounce rate analyzer 716 receives the inputs from both the bounce counter 708 and the visit session counter 702 and calculates a ubiquitous metric of web site performance that represents which fraction of web site visitors are leaving the web site without consuming any information.

As mentioned above, the user activity analyzer 504 may control the time period and targeted user cohorts of each analysis by setting up an analyzing period 718 and user/user cohorts 720. In other words, each of the engagement score components analyzed by the user activity analyzer 504 may be associated with a specific analyzing period (e.g., the year of 2014) and/or a specific user or user cohort (e.g., users from Florida).

In this embodiment, the user engagement score estimator 506 includes a user engagement score calculation unit 722, a model optimization unit 724, and a user activity log database 726. The user engagement score calculation unit 722 obtains the scoring model 509 and uses the scoring model 509 to estimate engagement scores based on the analyzed engagement score components from the user activity analyzer 504. In one example, the scoring model 509 includes a linear combination of a plurality of engagement score components, each of which is associated with one or more parameters. For ease of references, the user activity variables described above are summarized in Table 1 below:

TABLE 1

| Variable | Abv. | Description |
|---|---|---|
| Time-on-site | t | Total time spent on site |
| Visits | v | Number of browsing sessions |
| Page views | p | Number of pages loaded |
| Bounces | b | Number of visits lasting less than a threshold |

The engagement score e may be the linear combination of three logistic functions (engagement score components):

$$e = a \cdot f ( \frac{b}{v} ) + b \cdot g ( \frac{p}{v} ) + c \cdot h ( \frac{t}{v} ) , \qquad ( 2 )$$

where a, b, and c, are weights of each engagement score component in the liner combination. As parts of the parameters associated with each engagement score component, the weights may be manually set or automatically learned. In one example, a, b, and c are equal to 4, 2, and 4, respectively. All three functions f, g, and h may be logistic functions of the form in Equation (1) as mentioned above.

The model optimization unit 724 in this embodiment is configured to optimize the parameters associated with each engagement score component in the scoring model 509. For example, the parameters may include the weights a, b, and c of each engagement score component in the liner combination and α and β within each logistic function of the engagement score components. The model optimization unit 724 may set and adjust one or more parameters manually by an operator based on prior knowledge and experience or automatically optimize and update the values of the parameters using any known machine learning approaches based on historical user activity log data collected and stored in the user activity log database 726. That is, the parameters may be determined based, at least in part, on the information of past user activities. The model optimization unit 724 may also determine the parameters in a hybrid manner: manually setting up the initial values of the parameters and then automatically updating the values based on feedback. The details of determining optimized parameter values will be described below with respect to some initial experiment results.

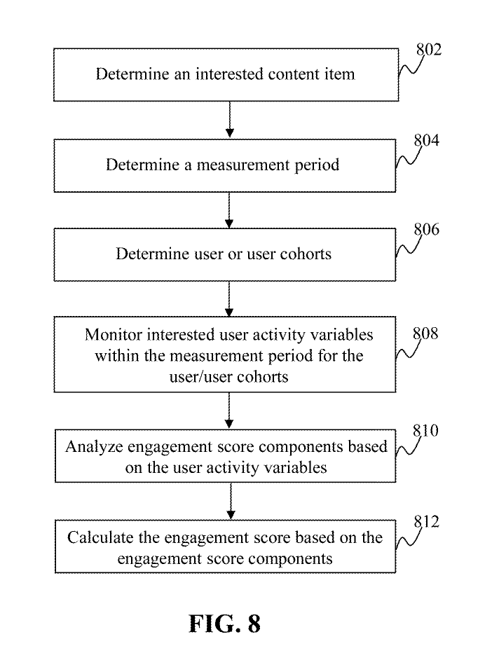

FIG. 8 is a flowchart of an exemplary process for a user engagement measurement engine, according to an embodiment of the present teaching. Starting at 802, the content item of interest is determined That is, a specific content item of which its engagement score to be estimated is determined. At 804 and 806, the measurement period and the targeted user or user cohort are determined as well. For example, an advertiser may specify an advertisement and request the engagement score of that advertisement to be estimated within a time period of next month for female users. At 808, user activity variables of interests are monitored within the measurement time period for the targeted user or user cohorts. It is understood that the targeted user cohort may be the general user population. At 810, engagement score components are analyzed based on the user activity variables. At 812, the engagement score is calculated based on the engagement score components. Various parameters may be used in the calculation as mentioned above.

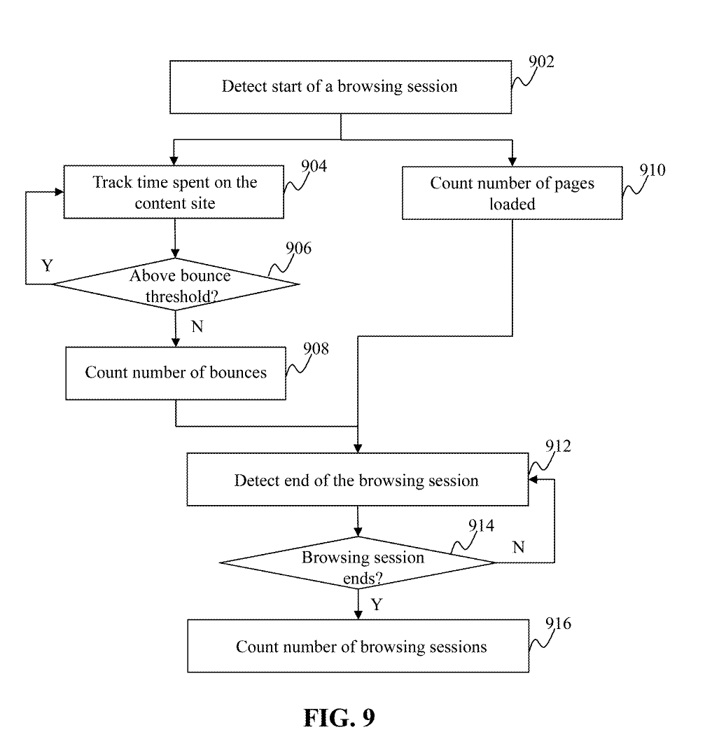

FIG. 9 is a flowchart of an exemplary process for a user activity monitor, according to an embodiment of the present teaching. In this embodiment, the four variables listed in Table 1 are tracked and recorded. At 902, the start of a new user browsing session (web site visit) is detected. For example, a user lands on an advertiser's web site after the user clicks an advertisement linking to the web site. The event of starting a new user browsing session thus initiates all subsequent events related to the user's visiting to the web site. At 904, the time that the user spending on the web site within the browsing session is tracked. At 906, it keeps tracking whether the time-on-site is above the bounce threshold. If the browsing session ends when the time-on-site is below the bounce threshold, then at 908, a bounce event is counted. Otherwise, the time-on-site is continuously tracked. In parallel, the number of web pages loaded in the web site is counted as well at 910. At 912, the end of the browsing session is detected. If it is found that the user finishes the browsing session at 914, then a visit event is counted at 916. Otherwise, the end of the browsing session is continuously monitored.

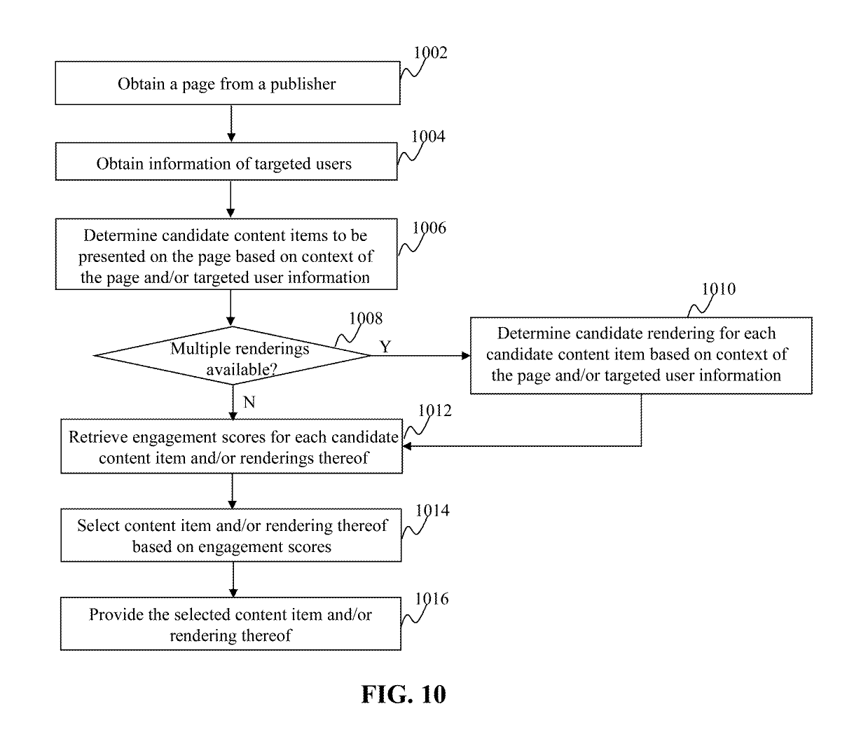

FIG. 10 is a flowchart of an exemplary process for a content serving engine, according to an embodiment of the present teaching. As mentioned above, engagement scores for each candidate content item or rendering thereof may be used as a basis for selecting and delivering optimal content items. At 1002, a page is obtained from a publisher's assets. The page is considered as the context in which an optimal content item is to be presented. At 1004, information of targeted user(s) is obtained, such as geo-location information and demographic information. At 1006, candidate content items are determined based on the context of the page and/or targeted user information. At 1008, whether multiple renderings of a candidate content item are available is determined. If a candidate content item has multiple renderings, then at 1010, suitable candidate rendering(s) are determined based on the context of the page and/or the targeted user information. At 1012, engagement scores of each candidate content item (and renderings if they have been determined at 1010) are retrieved. At 1014, an optimal content item (and an optimal rendering if available) is selected from the candidates by comparing their engagement scores. At 1016, the selected optimal content item (and the optimal rendering if available) is provided on the page of the publisher to the target users. As mentioned above, engagement scores of content items may be estimated for a specific user or user cohort. In providing content to targeted users as described in this embodiment, the retrieved engagement scores may have been estimated for a user cohort that shares one or more characteristics with the targeted users. For example, if the targeted viewers of an advertisement are teenage girls, then the engagement scores retrieved for candidate advertisements may have been estimated for a set of users who are teenage girls as well or at least share certain characteristics with teenage girls.

Preliminary experiments have been performed for optimizing the parameters associated with the engagement score components in the scoring model 509. In one example related to the bounce rate component, a bounce is defined to be a visit to a web site that lasts less than 5 seconds. Let b represent the number of bounces for a web site, and v be the number of visits, then the bounce rate is b/v. The bounce rate is a ubiquitous metric of website performance that represents which fraction of web site visitors are leaving the web site without consuming any information. For example, a bounce rate below 50% may be considered to be good. That implies that at least half of visitors are engaging with the web site.

To make a function of bounce rate that rewards bounce rates below 50%, a is set to a negative number to flip the function and encourage low values. The center of the logistic function described in Equation (1) is also set to be at what is considered a neutral value. The median from known experiment data is about 60%, so β is set to be 0.6. That gives the following function of bounce rate:

$$f ( \frac{b}{v} ) = \frac{1}{1 + {e}^{\frac{( b \text{/} v ) - 0.6}{0.08}}} . \qquad ( 3 )$$

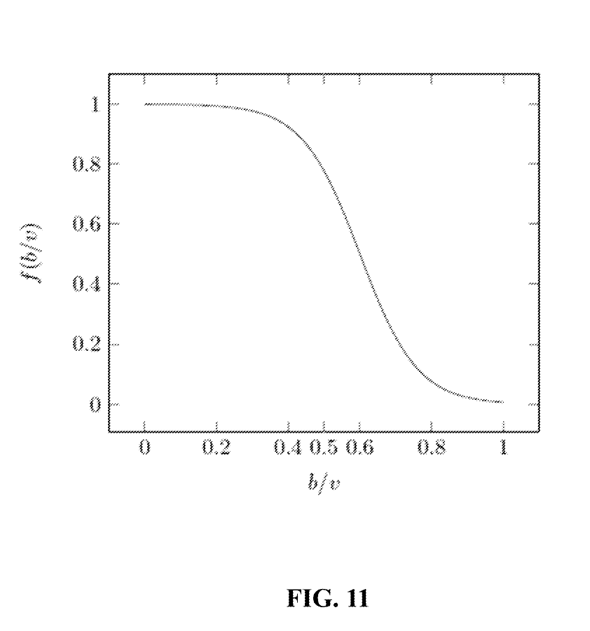

Equation (3) is shown in FIG. 11, which illustrates the contribution of bounce rate to engagement score as a function of bounce rate. As shown in FIG. 11, bounce rate makes a full contribution to the engagement score as it approaches zero.

In another example related to the page views per visit component, using the variables defined in Table 1, the number of page views per visit is expressed as p/v. A function is constructed so that when page views per visit is 1, the score is low and when it reaches 2 the score is much higher. This behavior is encapsulated in Equation (4):

$$g ( p \text{/} v ) = \frac{1}{1 + {e}^{- \frac{( p \text{/} v ) - 1.25}{0.2}}} . \qquad ( 4 )$$

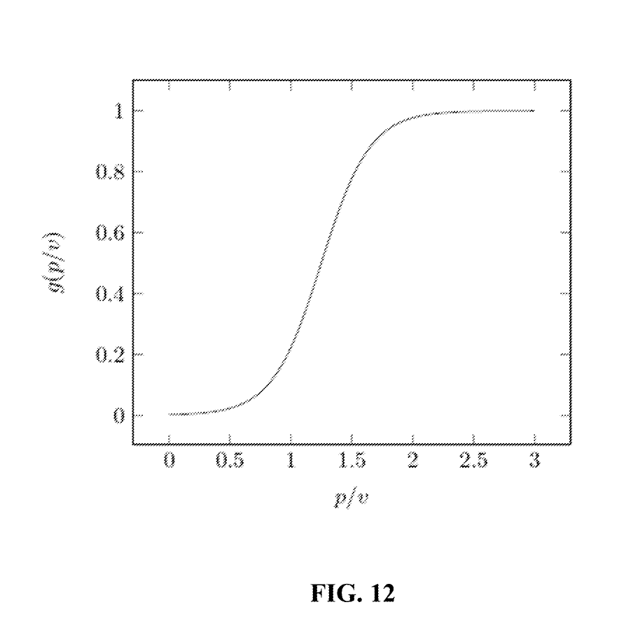

Equation (4) is shown in FIG. 12, which illustrates the contribution of page views per visit to engagement score. As shown in FIG. 12, the component reaches a maximum as page views per visit reaches >3.

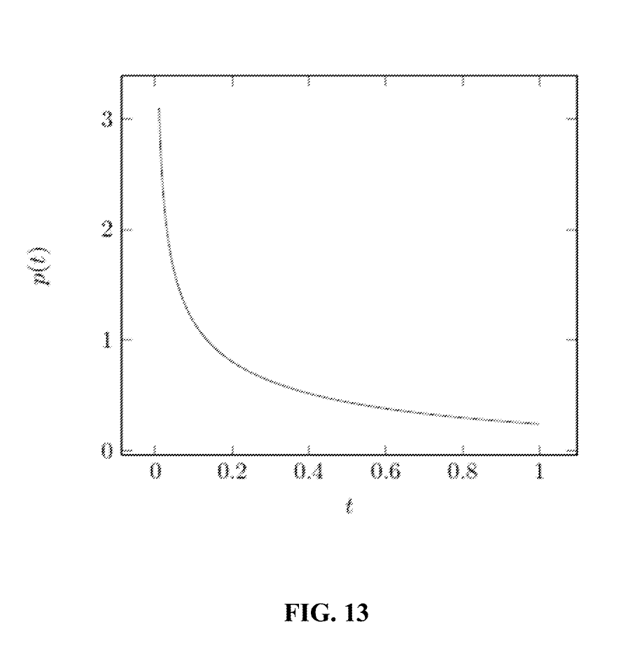

In still another example related to the time-on-site per visit (average time-on-site) component, using the variables defined in Table 1, the average time-on-site per visit is expressed as t/v. Known experiment results have shown that time-on-site can be modeled by a Weibull distribution. Furthermore, 98.5% of the sampled web sites are modeled by a Weibull distribution with shape parameter k<1. A Weibull with shape parameter below 1 is used to model the failure time for parts in which the failure rate decreases with age—also known as negative aging. Based on known experiment results, the probability density function (PDF) for a Weibull distribution with shape parameter k=0.65 and scale parameter λ=1 is shown in FIG. 13.

It is difficult to be notified when a user leaves a web page without negatively impacting the user experience. For example, JavaScript could be used to prevent navigation away from a web page until a tracking server is notified. However, if the server goes down or is latent, the user will be delayed from navigating to the next page. Hence, in one example, time-on-site is sampled by sending “heartbeat” signals in the background. The delay between heartbeat signals needs to be chosen carefully because trivial schemes can introduce data anomalies. Consider a scenario where heartbeat signals are sent every 10 seconds. Since most visitors drop off quickly, it would appear that most users were on the web site for 0 seconds. In reality, it takes these users several seconds to screen the web site and leave.

It is understood that heartbeat signals should be sent at a fast rate initially and progressively less frequently the longer a user is on a web page. To mathematically formulate this, a decision needs to be made on exactly what is an acceptable coarseness. Based on the preliminary experience results, it is decided that the sampling frequency should be done so that an equal part of the browser population falls between heartbeat signals. This prevents any part of the population from exerting more influence of the time-on-site variable than another. In order to break the population into equally sized intervals, the CDF of the Weibull distribution is considered and presented in Equation (5):

F(x)=1−e^{-(x/λ)}^{^{k}} (5).

By taking the inverse, Equation (6) is obtained:

F⁻¹(x)=λ(−log(1−x))(1/k) (6).

To send heartbeat signals that capture equally sized groups, heartbeat signals need to be sent at equally spaced quantiles of the CDF. Let Δε[0,1] be the quantile size. A heartbeat signal i is sent at F⁻¹(iΔ) seconds from the beginning of a page view. Selecting the quantile size Δ=0.01 means approximately one percent of users will drop off between each heartbeat signal.

After sampling time-on-site, a function of time-on-site that controls its contribution to the engagement score needs to be found. Known experiment results have found that 80% of web pages were modeled by λ≦70. The scale parameter λ controls the midpoint of the CDF because 1−e⁻(λ/λ)^{k}=1−e⁻¹≈0.63. Hence it is known that for 80% of web sites, over half of the users drop off before they view the web page for 70 seconds. Due to this finding, 70/60≈1.16 minutes is used as one example of the midpoint of for the time-on-site per visit engagement score component, which can be seen in Equation (7):

$$h ( t \text{/} v ) = \frac{1}{1 + {e}^{\frac{ϰ - 1.16}{- 0.2}}} . \qquad ( 7 )$$

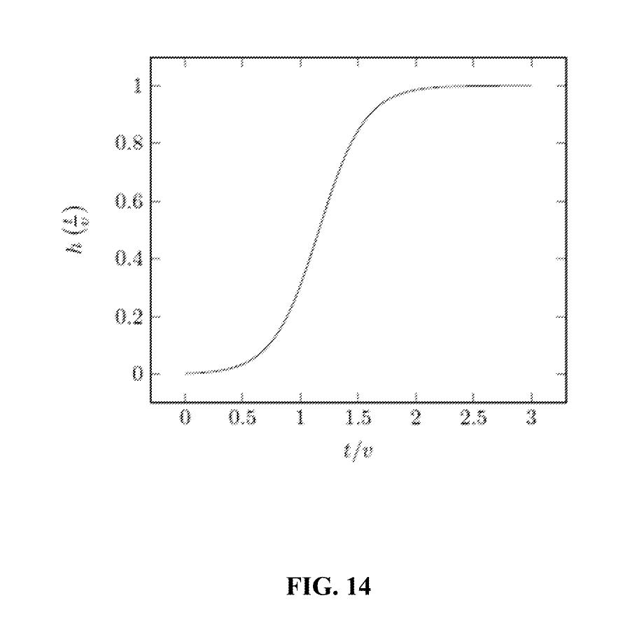

Equation (7) is shown in FIG. 14, which illustrates average time-on-site's contribution to engagement score.

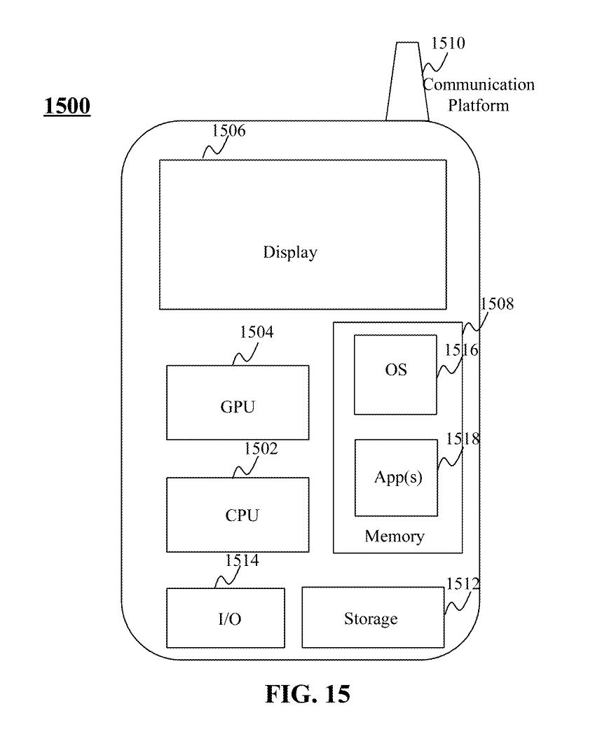

FIG. 15 depicts the architecture of a mobile device which can be used to realize a specialized system implementing the present teaching. In this example, the user device on which content is presented and interacted with is a mobile device 1500, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1500 in this example includes one or more central processing units (CPUs) 1502, one or more graphic processing units (GPUs) 1504, a display 1506, a memory 1508, a communication platform 1510, such as a wireless communication module, storage 1512, and one or more input/output (I/O) devices 1514. Any other suitable component, including but not limited to a system bus or a controller (not shown), may also be included in the mobile device 1500. As shown in FIG. 15, a mobile operating system 1516, e.g., iOS, Android, Windows Phone, etc., and one or more applications 1518 may be loaded into the memory 1508 from the storage 1512 in order to be executed by the CPU 1502. The applications 1518 may include a browser or any other suitable mobile apps for receiving and interacting with content on the mobile device 1500. User interactions with the content may be achieved via the I/O devices 1514 and provided to the user engagement measurement engine 102 and/or the content serving engine 104 via communication platform 1510.

To implement various modules, units, and their functionalities described in the present disclosure, computer hardware platforms may be used as the hardware platform(s) for one or more of the elements described herein (e.g., the user engagement measurement engine 102 and the content serving engine 104 described with respect to FIGS. 1-14). The hardware elements, operating systems and programming languages of such computers are conventional in nature, and it is presumed that those skilled in the art are adequately familiar therewith to adapt those technologies to online user engagement measurement as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

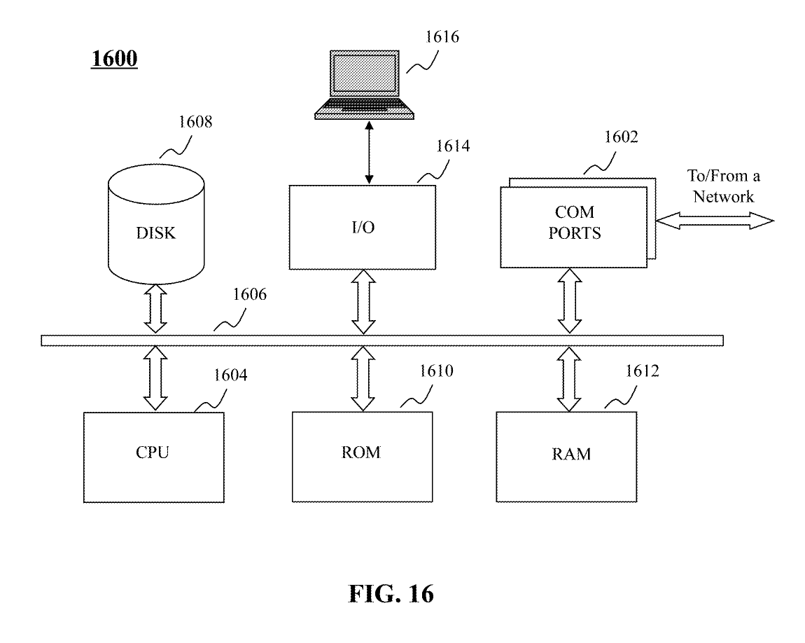

FIG. 16 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1600 may be used to implement any component of online user engagement measurement techniques, as described herein. For example, the user engagement measurement engine 102 and the content serving engine 104, etc., may be implemented on a computer such as computer 1600, via its hardware, software program, firmware, or a combination thereof. Although only one such computer is shown, for convenience, the computer functions relating to online user engagement measurement as described herein may be implemented in a distributed fashion on a number of similar platforms, to distribute the processing load.

The computer 1600, for example, includes COM ports 1602 connected to and from a network connected thereto to facilitate data communications. The computer 1600 also includes a central processing unit (CPU) 1604, in the form of one or more processors, for executing program instructions. The exemplary computer platform includes an internal communication bus 1606, program storage and data storage of different forms, e.g., disk 1608, read only memory (ROM) 1610, or random access memory (RAM) 1612, for various data files to be processed and/or communicated by the computer, as well as possibly program instructions to be executed by the CPU 1604. The computer 1600 also includes an I/O component 1614, supporting input/output flows between the computer and other components therein such as user interface elements 1616. The computer 1600 may also receive programming and data via network communications.

Hence, aspects of the methods of online user engagement measurement and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator into the hardware platform(s) of a computing environment or other system implementing a computing environment or similar functionalities in connection with online user engagement measurement. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the online user engagement measurement as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method comprising:
receiving, via a content serving engine, a request to present a piece of web content in a publisher's web page, wherein the piece of web content is associated with a content provider independent of the publisher;
querying the content provider's server for one or more candidate web content items in response to the request;
determining respective engagement scores for the one or more candidate web content items, wherein the respective engagement scores are based on web activity information for one or more targeted users with respect to the publisher's web page, other web pages associated with the publisher, or a combination thereof;
selecting the piece of web content from among the one or more candidate web content items based on the respective engagement scores; and
transmitting, via the content server engine, the selected piece of web content for presentation in the publisher's web page.

2. The method of claim 1, further comprising:
determining respective other engagement scores for one or more candidate renderings of the one or more candidate web content items; and
selecting a rendering from among the one or more candidate renderings based on the respective other engagement scores,
wherein the transmitting of the selected piece of web content includes transmitting the selected rendering for presentation in the publisher's web page.

3. The method of claim 2, further comprising:
retrieving the publisher's web page from an asset server of the publisher; and
using the web page as further context information for the selecting of the piece of web content from among the one or more candidate web content items, the selecting of the rendering from among the one or more candidate renderings, or a combination thereof.

4. The method of claim 2, further comprising:
storing the respective engagement stores on a content item/publisher pair basis in an engagement score database.

5. The method of claim 1, further comprising:
obtaining an engagement score model that includes a linear combination of a plurality of components associated with one or more parameters,
wherein the selecting of the piece of web content from among the one or more candidate web content items is further based on the engagement score model.

6. The method of claim 5, wherein the one or more parameters include a time-on-site parameter, a number of visits parameter, a number of page views parameter, a bounce parameter, or a combination thereof.

7. The method of claim 5, further comprising:
monitoring additional user activity information following a presentation of the selected piece of web content in the publisher's web page; and
updating the engagement score model, the respective engagement scores, or a combination thereof based on the additional user activity information.

8. The method of claim 1, further comprising:
receiving an input for specifying a time period, the one or more targeted users, a cohort of the one or more targeted users, or a combination thereof,
wherein the respective engagement scores are estimated with respect to the time period, the one or more targeted users, the cohort, or a combination thereof.

9. (canceled)

10. (canceled)

11. The method of claim 1, wherein
the web activity information is detected from a set of users, and
the one or more targeted users share one or more characteristics with the set of users.

12. A system having at least one processor, storage, and a communication platform capable of connecting to a network for user engagement measurement, comprising:
a user engagement measurement engine configured to
receive a request to present a piece of web content in a publisher's web page, wherein the piece of web content is associated with a content provider independent of the publisher, and
query the content provider's server for one or more candidate web content items in response to the request;
a user engagement score estimator configured to
determine respective engagement scores for the one or more candidate web content items, wherein the respective engagement scores are based on web activity information for one or more targeted users with respect to the publisher's web page, other web pages associated with the publisher, or a combination thereof;
a content selection unit configured to
select the piece of web content from among the one or more candidate web content items based on the respective engagement scores; and
a content rendering unit configured to
transmit the selected piece of web content for presentation in the publisher's web page.

13. The system of claim 12, wherein
the user engagement score estimator is further configured to determine respective other engagement scores for one or more candidate renderings of the one or more candidate web content items; and
the content selection unit is further configured to select a rendering from among the one or more candidate renderings based on the respective other engagement scores,
wherein the transmitting of the selected piece of web content includes transmitting the selected rendering for presentation in the publisher's web page.

14. The system of claim 12, further comprising:
a context matching unit configured to
retrieve the publisher's web page from an asset server of the publisher; and
use the web page as further context information for the selecting of the piece of web content from among the one or more candidate web content items, the selecting of the rendering from among the one or more candidate renderings, or a combination thereof.

15. The system of claim 12, further comprising:
an engagement score database configured to store the respective engagement scores on a content item/publisher pair basis.

16. The system of claim 12, further comprising:
an engagement scoring model that includes a linear combination of a plurality of components associated with one or more parameters,
wherein the selecting of the piece of web content from among the one or more candidate web content items is further based on the engagement score model.

17. The system of claim 16, wherein the one or more parameters include a time-on-site parameter, a number of visits parameter, a number of page views parameter, a bounce parameter, or a combination thereof.

18. The system of claim 16, further comprising:
a user activity monitor configured to monitoring additional user activity information following a presentation of the selected piece of web content in the publisher's web page; and
wherein the engagement score model, the respective engagement scores, or a combination thereof are updated based on the additional user activity information.

19. The system of claim 12, wherein the user engagement score estimator is further configured to
receive an input for specifying a time period, the one or more targeted users, a cohort of the one or more targeted users, or a combination thereof,
wherein the respective engagement scores are estimated with respect to the time period, the one or more targeted users, the cohort, or a combination thereof.

20. A non-transitory machine readable medium having information recorded thereon for user engagement measurement, wherein the information, when read by a machine, causes the machine to perform the steps of:
receiving, via a content serving engine, a request to present a piece of web content in a publisher's web page, wherein the piece of web content is associated with a content provider independent of the publisher;
querying the content provider's server for one or more candidate web content items in response to the request;
determining respective engagement scores for the one or more candidate web content items, wherein the respective engagement scores are based on web activity information for one or more targeted users with respect to the publisher's web page, other web pages associated with the publisher, or a combination thereof;
selecting the piece of web content from among the one or more candidate web content items based on the respective engagement scores; and
transmitting, via the content server engine, the selected piece of web content for presentation in the publisher's web page.

21. The medium of claim 20, wherein the machine is further caused to perform the steps of:
determining respective other engagement scores for one or more candidate renderings of the one or more candidate web content items; and
selecting a rendering from among the one or more candidate renderings based on the respective other engagement scores,
wherein the transmitting of the selected piece of web content includes transmitting the selected rendering for presentation in the publisher's web page.

22. The medium of claim 21, wherein the machine is further caused to perform the steps of:
retrieving the publisher's web page from an asset server of the publisher; and
using the web page as further context information for the selecting of the piece of web content from among the one or more candidate web content items, the selecting of the rendering from among the one or more candidate renderings, or a combination thereof.

23. The medium of claim 20, wherein the machine is further caused to perform the steps of:
storing the respective engagement stores on a content item/publisher pair basis in an engagement score database.

24. The medium of claim 20, wherein the machine is further caused to perform the steps of:
obtaining an engagement score model that includes a linear combination of a plurality of components associated with one or more parameters,
wherein the selecting of the piece of web content from among the one or more candidate web content items is further based on the engagement score model, and
wherein the one or more parameters include a time-on-site parameter, a number of visits parameter, a number of page views parameter, a bounce parameter, or a combination thereof.

25. The medium of claim 20, wherein the machine is further caused to perform the steps of:
monitoring additional user activity information following a presentation of the selected piece of web content in the publisher's web page; and
updating the engagement score model, the respective engagement scores, or a combination thereof based on the additional user activity information.
